(19) United States
(12) Patent Application Publication
(10) Pub. No.: US 2024/0228360 A1
(43) Pub. Date: Jul. 11, 2024

(54) OPTICAL FIBER PRODUCTION APPARATUS AND OPTICAL FIBER PRODUCTION METHOD

(71) Applicant: SUMITOMO ELECTRIC INDUSTRIES, LTD., Osaka-shi, Osaka (JP)

(72) Inventors: Yuzuki KOBAYASHI, Osaka-shi, Osaka (JP); Shinji NAKAHARA, Osaka-shi, Osaka (JP)

(21) Appl. No.: 18/556,194

(22) PCT Filed: Apr. 22, 2022
(86) PCT No.: PCT/JP2022/018508

§ 371 Date: Oct. 19, 2023

(30) Foreign Application Priority Data
Apr. 22, 2021 (JP) 2021-072767

(51) Int. Cl. C03B 37/07; C03B 37/12; C03B 37/03; C03C 25/105

(52) U.S. Cl. CPC C03B 37/07; C03B 37/12; C03B 37/032; C03C 25/105

(57) ABSTRACT

An optical fiber manufacturing device including a guide roller mechanism configured to bring a traveling optical fiber into contact with a predetermined groove to guide the traveling optical fiber. The guide roller mechanism includes a plurality of guide roller bodies each of which is configured to be rotated and configured to guide a traveling optical fiber, and a guide roller rotation shaft fixing mechanism configured to rotatably support rotation shafts of at least two guide roller bodies among the plurality of guide roller bodies. The guide roller rotation shaft fixing mechanism includes a position adjustment mechanism configured to adjust, for each of the rotation shafts, a horizontal two-axis position of a horizontal plane including an axial direction, and an angle adjustment mechanism configured to adjust an inclination angle of each of the rotation shafts.

The present application claims priority based on Japanese Application No. 2021-072767 filed on Apr. 22, 2021, and incorporates all the contents described in the Japanese Application.

### TECHNICAL FIELD

The present disclosure relates to an optical fiber manufacturing device and an optical fiber manufacturing method.

### BACKGROUND ART

An optical fiber is manufactured by heating and melting a glass base material for an optical fiber in a heating furnace, and drawing the glass base material from below the heating furnace. A glass fiber drawn out from the heating furnace becomes an optical fiber through a cooling processing, an outer diameter measurement processing, a resin coating processing, and the like, and is conveyed while being guided, by an immediately-lower roller and the like, to be wound around a bobbin.

The glass fiber drawn from the heating furnace may have a slightly elliptical shape or a distorted circular shape. For this reason, for example, Patent Literature 1 discloses a structure in which a swing roller that swings around a predetermined vertical axis is provided downstream of an immediately-lower roller. When the swing roller is swung and an optical fiber sent from the immediately-lower roller is twisted, the optical fiber can be brought close to a perfect circular shape.

### CITATION LIST

### Patent Literature

Patent Literature 1: WO 2000/044680 A1

### SUMMARY OF INVENTION

An optical fiber manufacturing device according to an aspect of the present disclosure is an optical fiber manufacturing device including a guide roller mechanism configured to bring a traveling optical fiber into contact with a predetermined groove to guide the traveling optical fiber,
in which the guide roller mechanism includes:
   a plurality of guide roller bodies each of which is configured to be rotated and configured to guide a traveling optical fiber; and
   a guide roller rotation shaft fixing mechanism configured to rotatably support rotation shafts of at least two guide roller bodies among the plurality of guide roller bodies, and
the guide roller rotation shaft fixing mechanism includes:
   a position adjustment mechanism configured to adjust, for each of the rotation shafts, a horizontal two-axis position of a horizontal plane including an axial direction; and
   an angle adjustment mechanism configured to adjust an inclination angle of each of the rotation shafts.

An optical fiber manufacturing method according to an aspect of the present disclosure is an optical fiber manufacturing method for adjusting an attachment position of a plurality of guide roller bodies with respect to a guide roller mechanism, the optical fiber manufacturing method including the guide roller mechanism to which the plurality of guide roller bodies configured to guide a traveling optical fiber is attached, and a measurement device disposed facing the guide roller mechanism and including a distance sensor configured to measure a distance to the guide roller body,
the optical fiber manufacturing method including:
a step of moving the distance sensor to face a predetermined measurement point provided on a side surface of a first guide roller body;
a step of measuring, by the distance sensor, a distance from the predetermined measurement point provided on the side surface of the first guide roller body to a predetermined measurement reference plane provided in the measurement device;
a step of moving the distance sensor to face another measurement point, other than the predetermined measurement point, provided on the side surface of the first guide roller body;
a step of measuring, by the distance sensor, a distance from the other measurement point to the predetermined measurement reference plane;
a step of adjusting, based on results of measuring, an attachment position of the first guide roller body such that the side surface of the first guide roller body is parallel to the predetermined measurement reference plane;
a step of moving the distance sensor to face a predetermined measurement point provided on a side surface of a second guide roller body located downstream of the first guide roller body;
a step of measuring, by the distance sensor, a distance from the predetermined point provided on the side surface of the second guide roller body to the predetermined measurement reference plane provided in the measurement device;
a step of moving the distance sensor to face another measurement point other than the predetermined measurement point provided on the side surface of the second guide roller body;
a step of measuring, by the distance sensor, a distance from the other measurement point provided on the side surface of the second guide roller body to the predetermined measurement reference plane; and
a step of adjusting, based on results of measuring, an attachment position of the second guide roller body such that the side surface of the second guide roller body is parallel to the side surface of the first guide roller body.

### BRIEF DESCRIPTION OF DRAWINGS

FIG. 1 is a schematic diagram illustrating an optical fiber manufacturing device according to an aspect of the present disclosure.

FIG. 2 is a configuration diagram of a guide roller mechanism and a measurement device.

FIG. 3 is a perspective view of the guide roller mechanism.

FIG. 4 is an operation flowchart including adjustment of an attachment position of a rotation shaft.

FIG. 5A is a diagram illustrating distance measurement.

FIG. 5B is a diagram illustrating measurement points.

### DESCRIPTION OF EMBODIMENTS

### Technical Problem

An optical fiber is sent downstream while being guided by a guide roller body such as an immediately-lower roller. When a position and an orientation of each guide roller body do not coincide with a path line of the optical fiber, the optical fiber may suffer surface damage or the optical fiber may be twisted, since the optical fiber rides on a groove side surface of the guide roller body, for example. Therefore, it is desirable to align the guide roller bodies with high accuracy.

The present disclosure has been made in view of the above-described circumstances, and an object thereof is to provide an optical fiber manufacturing device and an optical fiber manufacturing method capable of aligning guide roller bodies with high accuracy.

### Advantageous Effects of Present Disclosure

According to the present disclosure, it is possible to align guide roller bodies with high accuracy.

### Descriptions of Embodiments

First, contents of an embodiment of the present disclosure will be listed and described.
(1) According to an aspect of the present disclosure, there is provided an optical fiber manufacturing device including a guide roller mechanism configured to bring a traveling optical fiber into contact with a predetermined groove to guide the traveling optical fiber,
in which the guide roller mechanism includes:
   a plurality of guide roller bodies each of which is configured to be rotated and configured to guide a traveling optical fiber; and
   a guide roller rotation shaft fixing mechanism configured to rotatably support rotation shafts of at least two guide roller bodies among the plurality of guide roller bodies, and
the guide roller rotation shaft fixing mechanism includes:
   a position adjustment mechanism configured to adjust, for each of the rotation shafts, a horizontal two-axis position of a horizontal plane including an axial direction; and
   an angle adjustment mechanism configured to adjust an inclination angle of each of the rotation shafts.

The guide roller rotation shaft fixing mechanism supports all the rotation shafts of the guide roller bodies, and adjusts the horizontal two-axis positions (also referred to as translation positions) and the inclination angles of the guide roller bodies. Accordingly, the translation positions of the guide roller bodies can be managed, or translation positions of guide rollers can be left as they are, and inclination of the guide rollers can be managed. Accordingly, the guide roller bodies can be aligned with high accuracy.
(2) In an aspect of the optical fiber manufacturing device of the present disclosure, the guide roller rotation shaft fixing mechanism includes an adjustment reference surface for adjusting the horizontal two-axis position of each of the rotation shafts, and for adjusting the inclination angle of each of the rotation shafts.

When the adjustment reference surface is used, the horizontal two-axis position and the inclination angle of each rotation shaft can be easily adjusted.
(3) In an aspect of the optical fiber manufacturing device of the present disclosure, the plurality of guide roller bodies include:
an immediately-lower roller configured to be rotated below a predetermined furnace, and configured to guide an optical fiber drawn out from the furnace and traveling along a vertical direction;
a suppressing roller configured to be rotated downstream of the immediately-lower roller, and configured to guide the optical fiber guided by the immediately-lower roller, the suppressing roller being located on an opposite side of the immediately-lower roller from the optical fiber guided by the immediately-lower roller and;
a twist adjustment roller configured to be rotated downstream of the suppressing roller, and configured to guide the optical fiber guided by the suppressing roller, the twist adjustment roller being located on an opposite side of the suppressing roller from the optical fiber guided by the suppressing roller; and
a plurality of guide rollers configured to be rotated downstream of the twist adjustment roller, and configured to guide the optical fiber guided by the twist adjustment roller toward a predetermined capstan.

By using the guide roller mechanism, it is possible to easily adjust the horizontal two-axis position and the inclination angle of each rotation shaft, even when the number of guide roller bodies is large.
(4) In an aspect of the optical fiber manufacturing device of the present disclosure, the predetermined furnace is a heating furnace configured to heat and melt a glass base material used for an optical fiber.

When the immediately-lower roller guides the optical fiber traveling along the vertical direction after being drawn out from the heating furnace, misalignment of the immediately-lower roller causes twist in the optical fiber accompanying the movement along an inner wall surface of a groove of the roller. When the guide roller mechanism is used, it is possible to align the immediately-lower roller and the surrounding rollers with high accuracy, and it is possible to prevent twist of the optical fiber accompanying the movement along the inner wall surface of the groove of the immediately-lower roller.
(5) According to an aspect of the present disclosure, there is provided an optical fiber manufacturing method for adjusting an attachment position of a plurality of guide roller bodies with respect to a guide roller mechanism, the optical fiber manufacturing method including the guide roller mechanism to which the plurality of guide roller bodies configured to guide a traveling optical fiber is attached, and a measurement device disposed facing the guide roller mechanism and including a distance sensor configured to measure a distance to the guide roller body,
the optical fiber manufacturing method including:
a step of moving the distance sensor to face a predetermined measurement point provided on a side surface of a first guide roller body;
a step of measuring, by the distance sensor, a distance from the predetermined measurement point provided on the side surface of the first guide roller body to a predetermined measurement reference plane provided in the measurement device;
a step of moving the distance sensor to face another measurement point, other than the predetermined measurement point, provided on the side surface of the first guide roller body;
a step of measuring, by the distance sensor, a distance from the other measurement point to the predetermined measurement reference plane;
a step of adjusting, based on results of measuring, an attachment position of the first guide roller body such that the side surface of the first guide roller body is parallel to the predetermined measurement reference plane;
a step of moving the distance sensor to face a predetermined measurement point provided on a side surface of a second guide roller body located downstream of the first guide roller body;
a step of measuring, by the distance sensor, a distance from the predetermined point provided on the side surface of the second guide roller body to the predetermined measurement reference plane provided in the measurement device;
a step of moving the distance sensor to face another measurement point other than the predetermined measurement point provided on the side surface of the second guide roller body;
a step of measuring, by the distance sensor, a distance from the other measurement point provided on the side surface of the second guide roller body to the predetermined measurement reference plane; and
a step of adjusting, based on results of measuring, an attachment position of the second guide roller body such that the side surface of the second guide roller body is parallel to the side surface of the first guide roller body.

By measuring the distances of a plurality of positions on the side surface of each guide roller body and adjusting the attachment position of each guide roller body, each guide roller body can be aligned with high accuracy, and twist of the optical fiber accompanying the movement along an inner wall surface of a groove of each guide roller body can be prevented.
(6) In an aspect of the optical fiber manufacturing method of the present disclosure, the number of the second guide roller bodies is four or more.

When the attachment positions of the respective guide roller bodies are adjusted such that the side surfaces of the respective guide roller bodies facing the guide roller mechanism are parallel, the attachment position of each guide roller body can be easily adjusted even when the number of guide roller bodies is four or more.

### Details of Embodiments

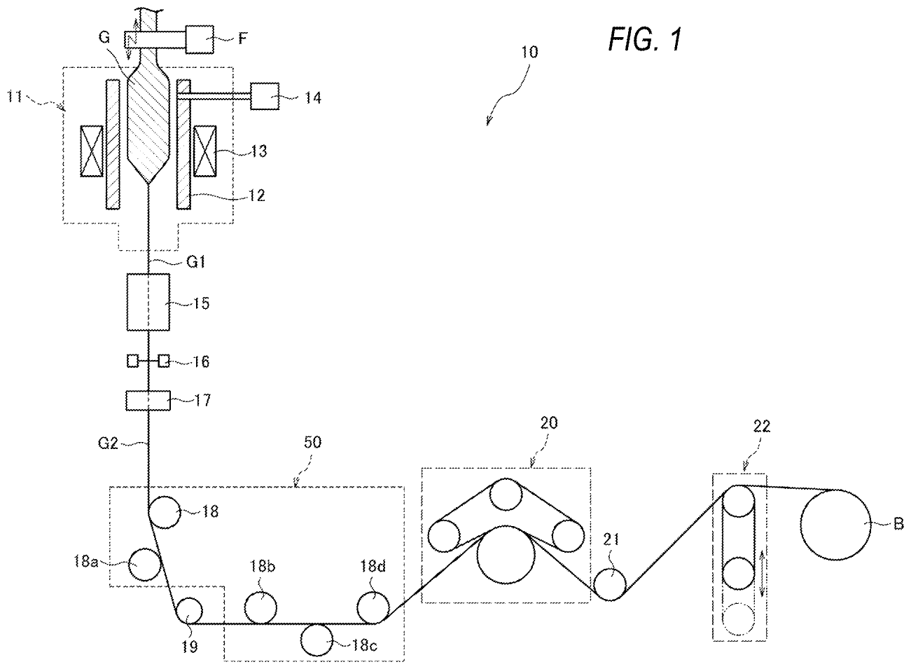

Hereinafter, specific examples of an optical fiber manufacturing device and an optical fiber manufacturing method according to the present disclosure will be described with reference to the accompanying drawings. FIG. 1 is a schematic diagram illustrating an optical fiber manufacturing device according to an aspect of the present disclosure.

As illustrated in FIG. 1, an optical fiber manufacturing device 10 includes, at a most upstream position, a heating furnace 11 configured to heat and soften a glass base material G used for an optical fiber.

The heating furnace 11 includes a cylindrical furnace core tube 12 to an inner side of which the glass base material G is supplied, a heating element 13 surrounding the furnace core tube 12, and a gas supply unit 14 configured to supply a purge gas into the furnace core tube 12.

An upper portion of the glass base material G is held by a base material feeding unit

F, and the glass base material G is fed into the furnace core tube 12 by using the base material feeding unit F. When a lower end portion of the glass base material G is heated by the heating element 13 and drawn downward, a glass fiber G1 serving as a center portion of an optical fiber G2 is formed.

The optical fiber manufacturing device 10 includes a cooling unit 15 downstream of the heating furnace 11. For example, a helium gas as a cooling gas is supplied to the cooling unit 15, and the glass fiber G1 drawn downward from the heating furnace 11 is cooled by the cooling unit 15. The cooling unit 15 may be a cooling system using a cooling gas other than the helium gas, as long as the glass fiber G1 can be cooled in a non-contact manner.

The optical fiber manufacturing device 10 includes an outer diameter measurement unit 16 downstream of the cooling unit 15. The outer diameter measurement unit 16 is configured to measure an outer diameter of the glass fiber G1 using, for example, laser light. The outer diameter of the cooled glass fiber G1 is measured by the outer diameter measurement unit 16 and then the glass fiber G1 is fed downward. The outer diameter measurement unit 16 may be implemented using a system other than the laser system, as long as the outer diameter of the glass fiber G1 can be measured in a non-contact manner.

The optical fiber manufacturing device 10 includes a coating unit 17 downstream of the outer diameter measurement unit 16. A urethane acrylate resin, which is an ultraviolet-curable resin, is applied to the glass fiber G1 whose outer diameter is measured. The urethane acrylate resin cures when irradiated with ultraviolet. Accordingly, the optical fiber G2 in which a resin layer is formed around the glass fiber G1 is obtained.

The optical fiber manufacturing device 10 includes a guide roller mechanism 50 downstream of the coating unit 17. The guide roller mechanism 50 includes, for example, an intermediately-lower roller 18, a suppressing roller 18a, a twist adjustment roller 18b, and guide rollers 18c and 18d. The intermediately-lower roller 18, the suppressing roller 18a, the twist adjustment roller 18b, and the guide rollers 18c and 18d are each provided with a groove of a predetermined shape such as a fiber traveling groove having a V-shaped cross section. The optical fiber G2 comes into contact with an inner wall surface of the groove and the optical fiber G2 is guided.

The intermediately-lower roller 18, the suppressing roller 18a, the twist adjustment roller 18b, and the guide rollers 18c and 18d correspond to the guide roller body of the present disclosure. Among them, the intermediately-lower roller 18 corresponds to the first guide roller body of the present disclosure, and the suppressing roller 18a, the twist adjustment roller 18b, and the guide rollers 18c and 18d correspond to the second guide roller body of the present disclosure. However, the second guide roller body may be four or more (for example, six) rollers.

The intermediately-lower roller 18 is disposed immediately below the heating furnace 11, and is configured to guide the optical fiber G2 drawn out from the heating furnace 11 and traveling along a vertical direction. The suppressing roller 18a is disposed downstream of the immediately-lower roller 18 and is disposed on the opposite side of the immediately-lower roller 18 from the optical fiber G2 guided by the immediately-lower roller 18, and is configured to press and guide the optical fiber G2 guided by the immediately-lower roller 18.

A swing roller 19 may be provided between the suppressing roller 18a and the twist adjustment roller 18b. The swing roller 19 is configured to swing about a predetermined vertical axis. The swing roller 19 is configured to be rotated downstream of the suppressing roller 18a, and is configured to change a traveling direction of the optical fiber G2 from the vertical direction to a horizontal direction, for example.

The twist adjustment roller 18b is disposed, for example, downstream of the swing roller 19 and on the opposite side (the same side as the intermediately-lower roller 18) of the suppressing roller 18a from the optical fiber G2 guided by the suppressing roller 18a, and is configured to guide the optical fiber G2 guided by the suppressing roller 18a while restricting twist of the optical fiber G2. The guide rollers 18c and 18d are disposed downstream of the twist adjustment roller 18b, and is configured to guide the optical fiber G2 guided by the twist adjustment roller 18b toward a predetermined capstan 20.

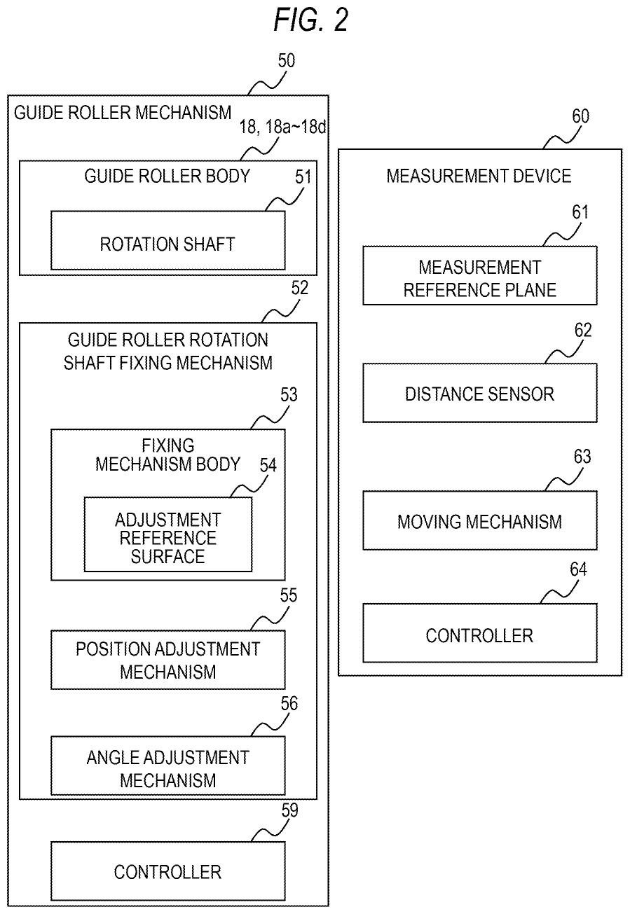

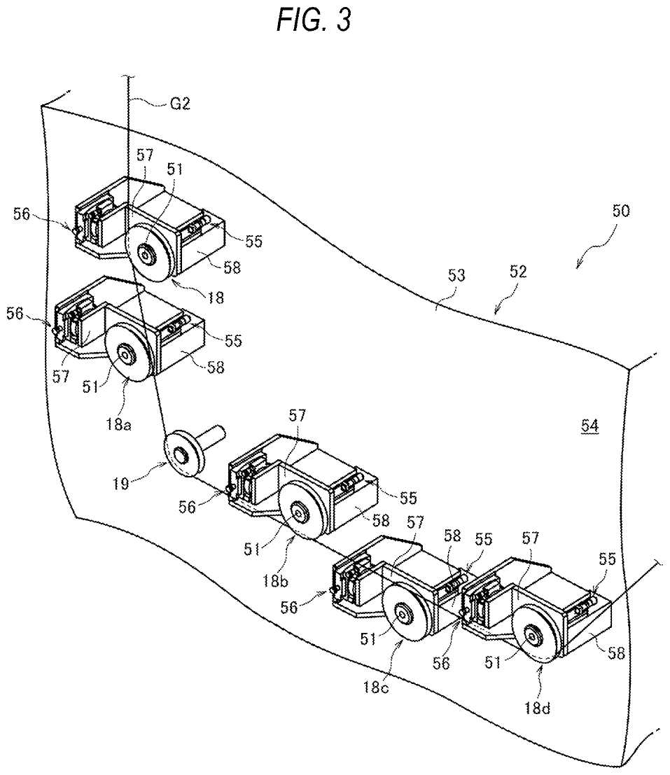

As illustrated in FIG. 2, the guide roller mechanism 50 includes a guide roller rotation shaft fixing mechanism 52. As illustrated in FIGS. 2 and 3, the guide roller rotation shaft fixing mechanism 52 includes a fixing mechanism body 53, a position adjustment mechanism 55, and an angle adjustment mechanism 56. Rotation shafts 51 of the intermediately-lower roller 18, the suppressing roller 18a, the twist adjustment roller 18b, and the guide rollers 18c and 18d are rotatably supported by arms 57 having an L shape in plan view.

In the embodiment, an example is described in which all the rotation shafts 51 of the intermediately-lower roller 18, the suppressing roller 18a, the twist adjustment roller 18b, and the guide rollers 18c and 18d are supported by the arms 57 provided at the fixing mechanism body 53. However, the present disclosure is not limited to this example. For example, at least two rotation shafts 51 of the immediately-lower roller 18, the suppressing roller 18a, the twist adjustment roller 18b, and the guide rollers 18c and 18d may be provided on the arm 57. Further, the fixing mechanism body 53 may be formed of, for example, a single metal plate or a structure in which a plurality of metal plates are integrated by being fixed with bolts or the like.

As illustrated in FIG. 3, the position adjustment mechanism 55 is attached to an adjustment reference surface 54 of the fixing mechanism body 53 via a support post 58. The angle adjustment mechanism 56 is placed on the position adjustment mechanism 55. The arm 57 is attached to the angle adjustment mechanism 56.

The position adjustment mechanism 55 and the angle adjustment mechanism 56 includes, for example, a plurality of adjusting screws, and is configured to adjust a position and an angle of the rotation shaft 51 by changing a tightening degree of each adjusting screw. The adjustment reference surface 54 of the fixing mechanism body 53 is used as a reference for adjusting a horizontal two-axis position of the rotation shaft 51 or adjusting an inclination angle of the rotation shaft 51.

The position adjustment mechanism 55 and the angle adjustment mechanism 56 may include a stage instead of the plurality of adjustment screws. Specifically, the position adjustment mechanism 55 includes, for example, an XY stage configured to adjust a horizontal two-axis position (also referred to as a translation position), of the rotation shaft 51, of a horizontal plane with a normal line in the vertical direction, that is, a horizontal plane including an axial direction. On the other hand, the angle adjustment mechanism 56 includes, for example, a gonio stage configured to vertically rotate the rotation shaft 51, and a horizontal rotation stage configured to be horizontally rotated.

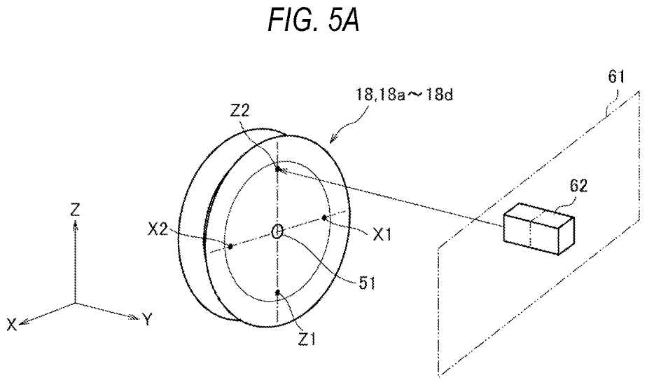

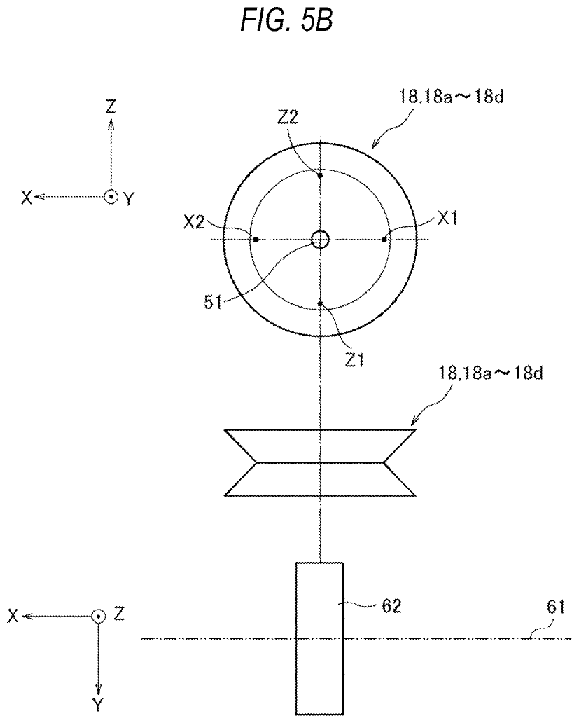

On the other hand, a measurement device 60 is provided at a position facing the guide roller mechanism 50. The measurement device 60 includes a distance sensor 62, a moving mechanism 63, and a control unit 64. The distance sensor 62 is implemented by, for example, a laser system or an infrared (IR) system, and a measurement result is output to the control unit 64. The measurement device 60 has a virtual measurement reference plane 61 that is used as a reference for measurement by the distance sensor 62. The moving mechanism 63 is configured to move the distance sensor 62, for example, in the horizontal direction (an X-axis direction illustrated in FIGS. 5A and 5B) or the vertical direction (a Z-axis direction illustrated in FIGS. 5A and 5B), based on a driving signal from the control unit 64.

The control unit 64 includes a CPU, a memory, and the like, is configured to load various types of programs and data stored in, for example, a ROM into a RAM, and is configured to execute the program. Accordingly, an operation of the measurement device 60 can be controlled based on the program.

When quantitatively adjusting the rotation shafts 51 by using the position adjustment mechanism (for example, the XY stage) 55 and the angle adjustment mechanism (for example, a gonio stage or a horizontal rotation stage) 56, a control unit 59 may be provided in the guide roller mechanism 50.

Returning to FIG. 1, the traveling direction of the optical fiber G2 guided by the guide rollers 18c and 18d is changed, by the guide roller 18d, from the horizontal direction to an obliquely upward direction, for example.

The optical fiber manufacturing device 10 further includes the capstan 20, a screening unit 21, and a dancer roller 22 downstream of the guide roller 18d. The optical fiber G2 is pulled up at a predetermined speed by the capstan 20, is given a predetermined tensile strain by the screening unit 21 in a state in which a predetermined tension is applied by the dancer roller 22, and then is wound around the bobbin B.

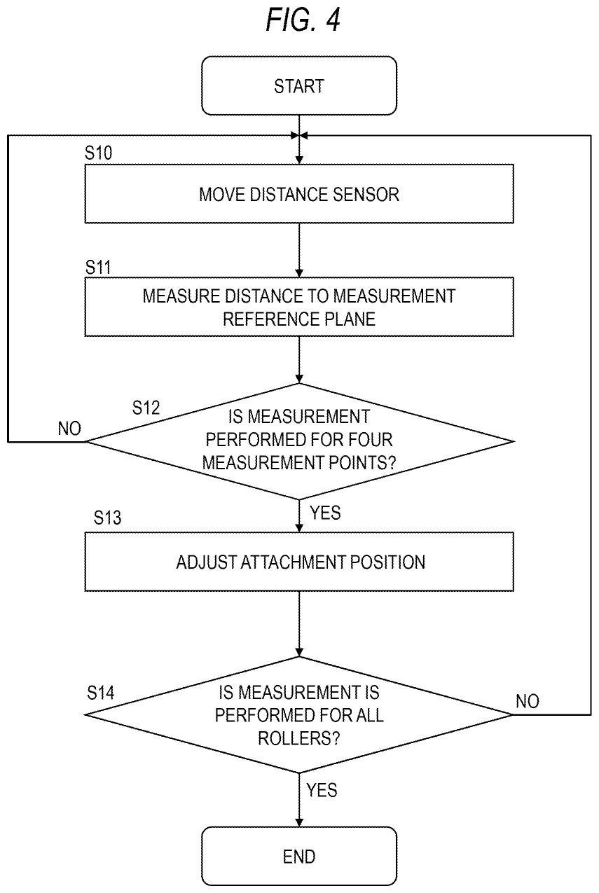

FIG. 4 is an operation flowchart including adjustment of an attachment position of the rotation shaft.

As described above, the case is assumed where, in the guide roller rotation shaft fixing mechanism 52, a total of six rollers including the immediately-lower roller 18, the suppressing roller 18a, the twist adjustment roller 18b, and the guide rollers 18c and 18d are installed. First, in order to adjust an attachment position of the immediately-lower roller 18, the distance sensor 62 is moved.

More specifically, as illustrated in FIGS. 5A and 5B, for example, four measurement points X1, X2, Z1, and Z2 are provided on a side surface of the immediately-lower roller 18. The measurement point X1 and the measurement point X2 are disposed on the X axis shown in the drawing, and are located at equal distances from a center of the rotation shaft 51. The measurement point Z1 and the measurement point Z2 are disposed on the Z axis shown in the drawing, and are located at equal distances from the center of the rotation shaft 51. Then, the distance sensor 62 is moved to face, for example, the predetermined measurement point Z2 provided on the side surface of the immediately-lower roller 18 (step S10 in FIG. 4).

Next, the distance sensor 62 measures a distance from the measurement point Z2 to the measurement reference plane 61 of the measurement device 60 (step S11). A measurement result is stored in the memory of the control unit 64.

Next, in step S12, the control unit 64 determines whether measurement is performed for the four measurement points X1, X2, Z1, and Z2 of the immediately-lower roller 18. When the measurement of all the measurement points is not completed (NO in step S12), the processing returns to step S10, the distance sensor 62 moves along the Z axis and faces the measurement point Z1 different from the measurement point Z2, for example.

The distance sensor 62 measures a distance from the measurement point Z1 to the measurement reference plane 61 (step S11), and stores a measurement result thereof.

Next, when the measurement of all the measurement points is not completed (NO in step S12), the distance sensor 62 moves along the Z axis and the X axis and faces the measurement point X1 different from the measurement points Z1 and Z2, for example (step S10). The distance sensor 62 measures a distance from the measurement point X1 to the measurement reference plane 61 (step S11) and also stores a measurement result thereof.

Thereafter, since the measurement of all the measurement points is not completed (NO in step S12), the processing returns to step S10, and the distance sensor 62 moves along the X axis and faces the measurement point X2 different from the measurement point X1, for example. The distance sensor 62 measures a distance from the measurement point X2 to the measurement reference plane 61 (step S11) and also stores a measurement result thereof.

When the measurement of all the measurement points is completed for the immediately-lower roller 18 (YES in step S12), the processing proceeds to step S13.

In step S13, the position adjustment mechanism 55 and the angle adjustment mechanism 56 adjust the attachment position of the rotation shaft 51 of the immediately-lower roller 18, based on the measurement results of the measurement points X1, X2, Z1, and Z2, such that the side surface of the immediately-lower roller 18 is parallel to the adjustment reference surface 54 of the fixing mechanism body 53 (step S13).

Next, the processing proceeds to step S14, in which the control unit 64 determines whether measurement is performed for the immediately-lower roller 18, the suppressing roller 18a, the twist adjustment roller 18b, and the guide rollers 18c and 18d. When the measurement for the suppressing roller 18a, the twist adjustment roller 18b, and the guide rollers 18c and 18d is not completed (NO in step S14), the processing returns to step S10, and the distance sensor 62 is moved in order to adjust an attachment position of the suppressing roller 18a.

For example, four measurement points X1, X2, Z1, and Z2 are provided on side surfaces of the suppressing roller 18a, the twist adjustment roller 18b, and the guide rollers 18c and 18d (FIG. 5A and FIG. 5B).

Then, the distance sensor 62 is moved to face the measurement point Z2 of the suppressing roller 18a (step S10 in FIG. 4), and a distance from the measurement point Z2 to the measurement reference plane 61 is measured (step S11) and stored.

Thereafter, the movement and measurement of the distance sensor 62 are repeated (NO in step S12, step S10, and step S11), and when the measurement of all the measurement points is completed for the suppressing roller 18a (YES in step S12), the processing proceeds to step S13. In step S13, based on the measurement results of the measurement points X1, X2, Z1, and Z2, the position adjustment mechanism 55 and the angle adjustment mechanism 56 adjust the attachment position of the rotation shaft 51 of the suppressing roller 18a such that the side surface of the suppressing roller 18a is parallel to the side surface of the immediately-lower roller 18 (and the adjustment reference surface 54).

Next, in order to adjust an attachment position of the twist adjustment roller 18b (NO in step S14), the distance sensor 62 is moved to face, for example, the measurement point Z2 of the twist adjustment roller 18b (step S10), and a distance from the measurement point Z2 to the measurement reference plane 61 is measured (step S11) and stored.

The movement and measurement of the distance sensor 62 are repeated (NO in step S12, step S10, and step S11) until the measurement of all the measurement points is completed for the twist adjustment roller 18b (YES in step S12). When the measurement of all the measurement points is completed (YES in step S12), the position adjustment mechanism 55 and the angle adjustment mechanism 56 adjust the attachment position of the rotation shaft 51 of the twist adjustment roller 18b, based on the measurement results of the measurement points X1, X2, Z1, and Z2, such that the side surface of the twist adjustment roller 18b is parallel to the side surface of the immediately-lower roller 18 (step S13).

Thereafter, similarly to the above, the movement and measurement of the distance sensor 62 are repeated for the guide rollers 18c and 18d (NO in step S12, step S10, and step S11). The position adjustment mechanism 55 and the angle adjustment mechanism 56 adjust attachment positions of the rotation shafts 51 of the guide rollers 18c and 18d, based on the measurement results of the measurement points X1, X2, Z1, and Z2, such that the side surfaces of the guide rollers 18c and 18d are parallel to the side surface of the immediately-lower roller 18 (step S13).

When the measurement for the immediately-lower roller 18, the suppressing roller 18a, the twist adjustment roller 18b, and the guide rollers 18c and 18d is completed (YES in step S14), the series of routines are ended.

In this way, the distances of four points on the side surfaces of the immediately-lower roller 18, the suppressing roller 18a, the twist adjustment roller 18b, and the guide rollers 18c and 18d are measured to adjust the attachment positions of the immediately-lower roller 18, the suppressing roller 18a, the twist adjustment roller 18b, and the guide rollers 18c and 18d. Thus, it is possible to align the immediately-lower roller 18, the suppressing roller 18a, the twist adjustment roller 18b, and the guide rollers 18c and 18d with high accuracy. More specifically, the immediately-lower roller 18 and the like conventionally disposed at accuracy of 29.5 mm to 30.2 mm, for example, can be disposed at high accuracy of 29.95 mm to 30.03 mm. As a result, the twist of the optical fiber accompanying the movement along the inner wall surfaces of the grooves of the immediately-lower roller 18, the suppressing roller 18a, the twist adjustment roller 18b, and the guide rollers 18c and 18d can be prevented.

It should be understood that the embodiment disclosed herein is illustrative and non-restrictive in every respect. The scope of the present disclosure is defined not by the above meaning but by the claims, and is intended to include all modifications within the meaning and scope equivalent to the claims.

For example, a method described below may be adopted. According to the method, a step of determining the accuracy of alignment of the roller is provided after step S12 in the flowchart of FIG. 4. When predetermined accuracy is satisfied, step S13 is skipped and the processing proceeds to step S14. When the predetermined accuracy is not satisfied, the processing proceeds to step S13 and then proceeds to step S10 again. The adjustment and measurement of the attachment position are repeated until the predetermined accuracy is satisfied.

### REFERENCE SIGNS LIST

10 optical fiber manufacturing device
11 heating furnace
12 furnace core tube
13 heating element
14 gas supply unit
15 cooling unit
16 outer diameter measurement unit
17 coating unit
18 immediately-lower roller (guide roller body)
18a suppressing roller (guide roller body)
18b twist adjustment roller (guide roller body)
18c, 18d guide roller (guide roller body)
19 swing roller
20 capstan
21 screening unit
22 dancer roller
50 guide roller mechanism
51 rotation shaft
52 guide roller rotation shaft fixing mechanism
53 fixing mechanism body
54 adjustment reference surface
55 position adjustment mechanism
56 angle adjustment mechanism
57 arm
58 support post
59 control unit
60 measurement device
61 measurement reference plane
62 distance sensor
63 moving mechanism
64 control unit
F base material feeding unit
G glass base material
G1 glass fiber
G2 optical fiber
B bobbin
X1, X2, Z1, Z2 measurement point

What is claimed is:

1. An optical fiber manufacturing device including a guide roller mechanism configured to bring a traveling optical fiber into contact with a predetermined groove to guide the traveling optical fiber,
wherein the guide roller mechanism includes:
a plurality of guide roller bodies each of which is configured to be rotated and configured to guide a traveling optical fiber; and
a guide roller rotation shaft fixing mechanism configured to rotatably support rotation shafts of at least two guide roller bodies among the plurality of guide roller bodies, and
the guide roller rotation shaft fixing mechanism includes:
a position adjustment mechanism configured to adjust, for each of the rotation shafts, a horizontal two-axis position of a horizontal plane including an axial direction; and
an angle adjustment mechanism configured to adjust an inclination angle of each of the rotation shafts.

2. The optical fiber manufacturing device according to claim 1,
wherein the guide roller rotation shaft fixing mechanism includes an adjustment reference surface for adjusting the horizontal two-axis position of each of the rotation shafts, and for adjusting the inclination angle of each of the rotation shafts.

3. The optical fiber manufacturing device according to claim 1,
wherein the plurality of guide roller bodies include:
an immediately-lower roller configured to be rotated below a predetermined furnace, and configured to guide an optical fiber drawn out from the furnace and traveling along a vertical direction;
a suppressing roller configured to be rotated downstream of the immediately-lower roller, and configured to guide the optical fiber guided by the immediately-lower roller, the suppressing roller being located on an opposite side of the immediately-lower roller from the optical fiber guided by the immediately-lower roller and;
a twist adjustment roller configured to be rotated downstream of the suppressing roller, and configured to guide the optical fiber guided by the suppressing roller, the twist adjustment roller being located on an opposite side of the suppressing roller from the optical fiber guided by the suppressing roller; and
a plurality of guide rollers configured to be rotated downstream of the twist adjustment roller, and configured to guide the optical fiber guided by the twist adjustment roller toward a predetermined capstan.

4. The optical fiber manufacturing device according to claim 3,
wherein the predetermined furnace is a heating furnace configured to heat and melt a glass base material used for an optical fiber.

5. An optical fiber manufacturing method for adjusting an attachment position of a plurality of guide roller bodies with respect to a guide roller mechanism, the optical fiber manufacturing method being used in an optical manufacturing device including the guide roller mechanism to which the plurality of guide roller bodies configured to guide a traveling optical fiber is attached, and a measurement device disposed facing the guide roller mechanism and including a distance sensor configured to measure a distance to the guide roller body,
the optical fiber manufacturing method comprising:
moving the distance sensor to face a first measurement point provided on a side surface of a first guide roller body;
measuring, by the distance sensor, a distance from the first measurement point provided on the side surface of the first guide roller body to a predetermined measurement reference plane provided in the measurement device;
moving the distance sensor to face a second measurement point, other than the first measurement point, provided on the side surface of the first guide roller body;
measuring, by the distance sensor, a distance from the second measurement point to the predetermined measurement reference plane;
adjusting, based on results of measuring, an attachment position of the first guide roller body such that the side surface of the first guide roller body is parallel to the predetermined measurement reference plane;
moving the distance sensor to face a third measurement point provided on a side surface of a second guide roller body located downstream of the first guide roller body;
measuring, by the distance sensor, a distance from the predetermined point provided on the side surface of the second guide roller body to the predetermined measurement reference plane provided in the measurement device;
moving the distance sensor to face a fourth measurement point other than the third measurement point provided on the side surface of the second guide roller body;
measuring, by the distance sensor, a distance from the fourth measurement point provided on the side surface of the second guide roller body to the predetermined measurement reference plane; and
adjusting, based on results of measuring, an attachment position of the second guide roller body such that the side surface of the second guide roller body is parallel to the side surface of the first guide roller body.

6. The optical fiber manufacturing method according to claim 5,
wherein the number of the second guide roller bodies is four or more.
